(19) United States
(12) Patent Application Publication
(10) Pub. No.: US 2013/0198776 A1
(43) Pub. Date: Aug. 1, 2013

(54) Mobile Device Remote Retour Channel

(71) Applicant: ActiveVideo Networks B.V., Hilversum (NL)

(72) Inventor: Ronald A. Brockmann, Utrecht (NL)

(73) Assignee: ActiveVideo Networks B.V., Hilversum (NL)

(21) Appl. No.: 13/668,004

(22) Filed: Nov. 2, 2012

Related U.S. Application Data
(63) Continuation of application No. PCT/NL2011/050308, filed on May 4, 2011.

(30) Foreign Application Priority Data
May 4, 2010 (NL) 2004670

(51) Int. Cl. H04N 21/41

(52) U.S. Cl. CPC H04N 21/4126
USPC 725/37

(57) ABSTRACT

System and methods for manipulating the display of images on a user's display device where the images originate from a processing device by means of a control device, such as a handheld device. The processing device and the control device are in network communication. Additionally, the processing device and a client device associated with the display device are also in network communication. The control device provides manipulation instructions using manipulation software to the processing device. The processing device may be a remote server or a local rendering device. The processing device renders one or more images based upon the manipulation instructions by combining encoded image fragments.

### CROSS-REFERENCE TO RELATED APPLICATIONS

The present U.S. Continuation Application claims priority from International Application PCT/NL2011/050308 having an International Filing Date of May 4, 2011 entitled Mobile Device Remote Retour Channel, which claims priority from the Netherlands application NL2004670 filed on May 4, 2010, and both priority applications are incorporated herein by reference in their entirety.

### TECHNICAL FIELD

The present invention relates to digital video image manipulation originating at a non-local source using a control device networked to a rendering device, wherein the rendering device is networked to a display device for presentation of the digital video image.

### BACKGROUND ART

Prior art systems allow for the control of digital video information provided over a network to a receiving device coupled to a display device using a remote control unit of the receiving device. For example, in a cable television system supporting interactive content, a user may control the interactive content using a remote control that accompanies the cable television set-top box. Generally, remote controls for set-top boxes provide for a limited number of user input options especially for communicating spatially related input requests with respect to the digital video information being displayed on the user's television. Current remote controls for cable television systems include arrow controls to indicate movement in one of four general directions (up, down, left and right). This type of input device and directional signal is acceptable for navigating digital video information that has been organized by the service provider in a grid-like structure, such as basic graphical program guides, but fails to provide the needed flexibility for more modern interactive Internet-like content.

### SUMMARY OF THE INVENTION

Embodiments of the present invention relates to a method for manipulating the display of images of an image display and/or user interface originating from an processing device such as an image source of a remote server and/or a storage medium on a local rendering device by means of a control device, such as a handheld device, of a user which is connected to a network and which makes contact with the remote server or the local rendering device via a network connection. Another embodiment of the invention relates to a control device, such as a device connected to a network, such as a handheld device, suitable for application in such a method. Another embodiment of the invention relates to a central server, a local rendering device and a system. Embodiments of the invention may further relate to computer software for executing such a method.

Known from the international patent application with publication number WO20081044916 of the same applicant, as this document is a system for providing image information to local users by means of a plurality of individual video streams on the basis of for instance a video codec. For this purpose, the images are generated by a plurality of individual applications that are executed on a central server and the individual video streams are generated in the central server. This patent application also includes a number of further optimizations of this general principle. The content of this patent application are attached hereto as Appendix A.

In the system described in Appendix A, use is made of a remote control as known for use with a standard set-top box for directly providing the set-top box with instructions that are provided to the central server via the network connection of the set-top box. Such a remote control has a large number of limitations in respect of the operation of the user interface.

In order to provide improvements in the operation of the user interface, the present invention provides a method for manipulating the display of images of an image display and/or user interface originating from an image source of a remote server and/or a storage medium on a local rendering device by means of a control device, such as a handheld device, of a user which is connected to a network and which makes contact with the remote server or the local rendering device via a network connection, wherein the method comprises steps for: the remote server or the local rendering device receiving manipulation instructions from the control device provided with manipulation software suitable for executing of the method by the control device; processing the manipulation instructions on the central server and/or the local rendering device, and sending image information from the central server and/or the local rendering device for displaying the images and/or the user interface for final display on a display device such as a TV or monitor.

An advantage of a method according to the present invention is that instructions can be received from the control device via a network connection. It hereby becomes possible to use a relatively advanced device as a control device, such as, a general-purpose computer device. Such a general-purpose computer device has a relative wealth of input options for the user, such as a touchscreen, and a motion detector. With the present invention, it becomes possible to provide such a relative wealth of input options to a user of a system according to the referenced international patent application, which is attached hereto as Appendix A. It further becomes possible to provide such a relative wealth of input options to the user of a local rendering device such as a video recorder, computer, media player and so on. Such a rendering device must for this purpose be provided with a network connection for receiving the instructions. Alternatively, it is possible to provide a direct mutual connection in similar manner to a known remote control by means of for instance an infrared connection or a cable.

It is further possible by means of the richer input options to make use of a large number of interactive applications, such as, games and chat.

According to a first embodiment, a method according to the present invention comprises steps for generating video codec operations, such as MPEG operations, on the basis of the input manipulation instructions, the MPEG operations being used for the image display. In combination with video processing operations as described in referenced International Patent Application publication '916 it is possible to apply the instructions for executing the video codec operations on the basis thereof. Operations hereby become possible because of the relatively rich user interface of the control device. Examples are of functions that can be performed with control device include zoom operations using multi-touch input or gestures.

In a further embodiment, the method comprises steps for changing the display of the user interface on the basis of the manipulation instructions. It is hereby possible for instance to navigate through a menu structure. It is for instance possible to switch between two menu screens by means of performing a swipe movement over a touchscreen. It is however, also possible to select and activate a submenu item and thereby switch to a further menu page.

The method more preferably comprises image processing operations which are operable within a video codec, such as the application of movement vectors and/or translation vectors for realizing displacement effects and/or zoom effects. It hereby becomes possible to select one of a plurality of small displayed images and subsequently enlarge this to full-screen. Compare this to the use of a photo page on the internet. If a user selects one of these images by means of a mouse, this is shown enlarged on the screen. It is possible by means of the present invention to show in for instance a user interface nine photos or moving video images, one of which the user selects which is then shown enlarged. It is further possible here by means of said zoom operations to gradually enlarge the image in a smooth movement starting from the already available, relatively small image. When the high-resolution larger image is available from the background data storage, the image is shown definitively in high quality. Such a situation can be timed such that it appears to the user as if the image is enlarged immediately following clicking, whereby there does not appear to be the latency of retrieval of the background image with a higher resolution.

In such image processing operations on the basis of the manipulation instructions from the control device use is more preferably made of inter-encoding and intra-encoding. Image processing operations known from the referenced International Patent Publication '916 can hereby be applied.

Manipulation instructions are preferably also applied which are entered by means of a touchscreen, such as sliding movements for scroll instructions or slide instructions, zoom in and out movements for zoom instructions, the instructions preferably being generated by means of multi-touch instructions. The user is hereby provided with a relatively great wealth of input options.

The instructions are more preferably generated by means of a user moving the control device, wherein these movements can be detected by means of a movement detector or a gravity detector arranged in the control device. It is for instance possible here to move for instance a level to the right in the menu structure by means of rotating the control device to the right or, alternatively, to move a level to the left in the menu structure by means of rotating the control device to the left. It also becomes possible for instance to implement an action effect as chosen by the user by means of shaking the control device.

The instructions more preferably comprise text input, speech input and/or image input. It hereby becomes possible in simple manner to input larger quantities of textual information. In a known remote control text is usually entered by means of successively selecting letters by means of a four-direction cursor key. According to the prior art this is very time-consuming and is obviated in effective manner by means of an aspect of the present preferred embodiment.

In order to provide greater security and identification of the user in relation to the central server or the local rendering device, a further embodiment provides steps for mutually pairing the central server and/or the local rendering device.

This is more preferably performed by the central server and/or local rendering device sending a code to the screen for input thereof in the control device and receiving from the control device information on the basis of which the input of the code can be verified.

Further methods of inputting data for pairing purposes can be executed by means of text input, gestures, motions, speech and/or image input.

A further embodiment according to the present invention relates to a control device, such as a device connected to a network, such as a handheld device.

The control device may include a central processing unit, at least one memory and preferably a touchscreen and/or a motion sensor, which are mutually connected to form a computer device for executing manipulation software for generating manipulation instructions.

The control device may also include manipulation software for generation by the control device of manipulation instructions for manipulating the image display and/or user interface.

Additionally, embodiments of the present invention may include transmitting means for either uni-directional or bi-directional transferring of the manipulation instructions by means of a network from the control device to the central server and/or local rendering device to a central server and/or local rendering device via the network connection. Advantages can be gained by means of such a control device together with a central server and/or a local rendering device as referred to in the foregoing and as will be described in greater detail below.

A further embodiment of the present invention relates to a central server for streaming a number of parallel user sessions from at least one server to at least one client device of a plurality of client devices for displaying the sessions on a screen connectable to a client device, wherein the sessions comprise video data and optional additional data such as audio data, wherein the central server comprises receiving means for receiving the instructions from a network connection, and wherein the central server comprises processing means for processing instructions comprising text input, gestures, motions, speech and/or image input. The processing means of the central server may be referred to as a processing device.

Another embodiment of the present invention relates to a local rendering device, such as a video recorder, computer, media player, for displaying a user session and/or video information on a screen, wherein the media player comprises receiving means for receiving the instructions from a network connection, and wherein the central server comprises processing means for processing instructions comprising text input, gestures, motions, speech and/or image input. Again, the processing means may be referred to as a processing device.

A further embodiment according to the present invention relates to a system for streaming a number of parallel user sessions from at least one server to at least one client device of a plurality of client devices for displaying the sessions on a screen connectable to a client device, wherein the sessions comprise video data and optional additional data such as audio data, wherein the central server comprises receiving means for receiving the instructions relating to display on a respective client from a plurality of control devices by means of a network connection, and wherein the central server comprises processing means for processing instructions comprising text input, gestures, motions, speech and/or image input.

The disclosed methodology may also be embodied in computer software on a tangible computer readable medium for execution by a central server, a local rendering device or another processor.

### BRIEF DESCRIPTION OF THE DRAWINGS

Such aspects according to the present invention provide respective advantages as stated in the foregoing and as described in detail herein below.

Further advantages, features and details of the present invention will be described in greater detail herein below on the basis of one or more preferred embodiments, with reference to the accompanying figures.

FIG. 1 shows a schematic representation of a preferred embodiment according to the present invention.

FIG. 2A shows a representation of an embodiment of the system and FIG. 2B shows a representation of the system shown in Appendix A.

### DETAILED DESCRIPTION OF SPECIFIC EMBODIMENTS

As used in the present description and claims, the term “processing device” may refer to either a local rendering device or a portion of a remote server that performs rendering.

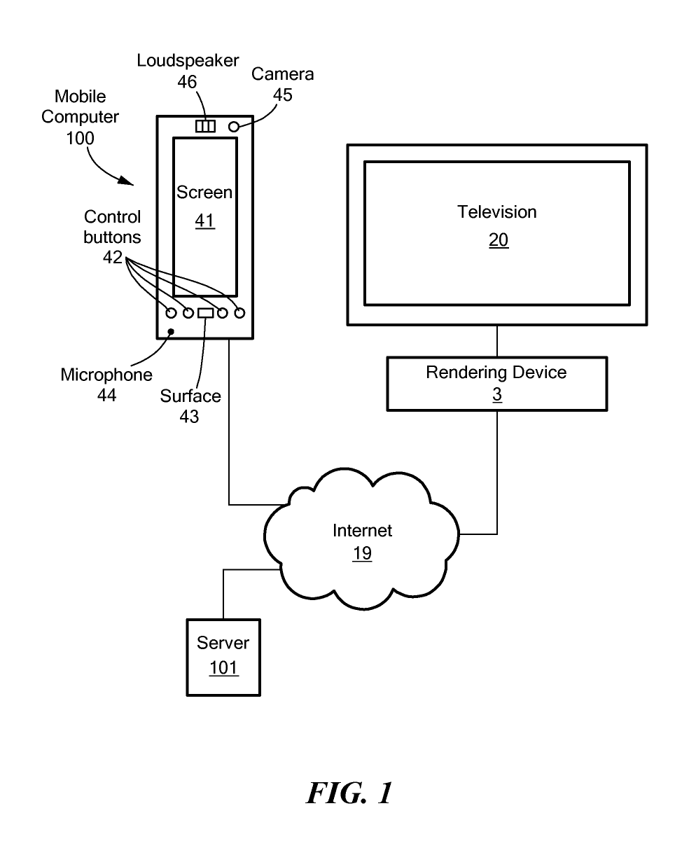

A first preferred embodiment (FIG. 1) according to the present invention relates to a mobile computer 100. This is similar to for instance a mobile phone. The mobile computer 100 comprises a screen 41, which is preferably touch-sensitive. The mobile computer also comprises four control buttons 42 arranged on the bottom side. A touch-sensitive surface 43 for navigation is situated between control buttons 42. Also situated on the bottom side is a microphone 44 for recording sounds such as voice sounds. A loudspeaker 46 for reproducing sounds is situated on the top side. Situated adjacently of loudspeaker 46 is a camera 45 for recording images. A camera (not shown), likewise for recording images, is also situated on the rear side. The images are further transmitted via set-top box 3 or rendering device 3 to television 20.

Disclosed up to this point is a per se known mobile computer, such as a mobile phone or a PDA. According to the present invention this mobile computer is provided with a software application for detecting input for the purpose of the present invention, and transmitting such input by means of a network connection. The software application is provided for this purpose with connecting means for making a connection to the network access means of the mobile computer. Access is hereby obtained to a wireless network, which is connected to the internet 19 or which is a separate wireless network. Alternatively, a fixed network is of course also possible. It is also possible in alternative manner for the wireless network to be a mobile network run by a mobile network operator.

Via the network connection 19, the mobile device 100 has contact with either the server 101 or local rendering device 3.

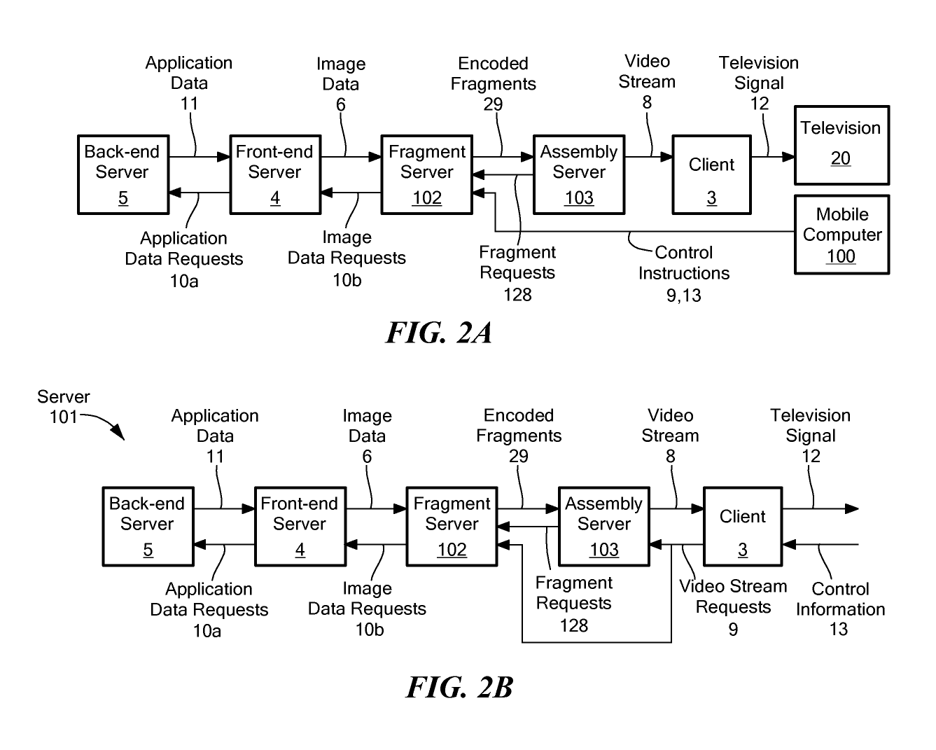

Server 101 can likewise be a schematic representation of the components 5, 4, 102, 103 of FIGS. 2A and 2B. The server 101 may include a back-end server 5, a fragment server 102, an assembly server 103 and a front-end server 4. The back-end server receives application data request 10 and produces application data that is passed to the front-end server 4. The front-end server receives in image data requests 10 and outputs image data 6 to a fragment server. The fragment server may encode fragments of a video frame into reusable components and store the fragment either locally or remotely. The fragment server proves the encoded fragments to an assembly server in response to both fragment requests from the assembly server and also video stream requests 9 that are received from a client device 3. The client device outputs a television signal 12 and receives as input control information 13 from a control device. FIG. 2B shows an embodiment of an environment as described in Appendix A, especially with respect to FIG. 9 of Appendix A. FIG. 2A shows a modification of the layout of the return path of the remote control executed by mobile computer 100. The return path runs via internet 19 (as shown in FIG. 1) directly from the mobile computer to server 102. Parallel use (not shown) can also be made here of the standard remote control of set-top box 3. This can however also be switched off.

The control information (control instructions 9, 13 which includes video stream requests) which mobile computer 100 transmits to server 102 (which forms part of server 101 of FIG. 1) is enriched according to the present invention with said input options in respect of text input, gestures, motions, speech and/or image input.

A plurality of accelerated operating options hereby becomes possible which would not be possible by means of the standard remote control with buttons. It becomes possible for gestures and movement of the control device to indicate the speed of the movement. A user can hereby determine in a dynamic manner how quickly an operation is performed, or for instance how much information is scrolled during performing of a single movement. It also becomes possible to rotate the image, for instance by describing a circle on the touchscreen or for instance rotating two fingertips on the screen. A further example is that the number of fingertips which operate the screen simultaneously determines which function is activated.

For transmission of the instructions from the mobile device to server 1 use is made of general internet technology, such as HTTP. The application on the mobile computer converts the touches on the touchscreen to parameters which are important for the user interface displayed on screen 20. In order to perform the sliding movement on the screen use is made of the “swipe true” parameter, and for the speed of the movement the parameter “velocity V”, wherein V is a value of the speed. Further parameters are provided in similar manner, such as pinching for zooming, a rotation movement for rotation and text for text input. Examples which are used are as follows.

An instruction takes the form of a URL for reaching the server, providing identification and providing an instruction. An instruction for transmitting an arrow up instruction from a user to the server is as follows: http://sessionmanager/key?clientid=avplay&key=up.

An instruction to perform a similar operation by means of an upward sliding movement on the touchscreen of the mobile computer is as follows: http://sessionmanager/key?clientid=avplay&key=up&swipe=true&velocity=3.24 which indicates that an upward movement has to be made at a speed 3.24. This achieves that the desired speed is likewise displayed by the user interface.

Through repeated use the user can learn which speed produces which practical effect. Alternatively, it is possible to allow the user to set individual preferred settings.

An instruction to zoom out in order to reduce in size a part of the image is as follows: http://sessionmanager/event?clientid=avplay&event=onscale&scale=2.11, this achieving that a pinching movement is performed on the image with a factor 2.11, whereby the part of the image that has been selected is reduced in size. It is conversely possible to zoom in using such a function.

If a user wishes to input text in the user interface, the following function can be used: http://sessionmanager/event?clientid=avplay&event=onstring&text=bladibla, whereby the text value “bladibla” is used in the user interface to give for instance a name to a photo or video fragment. Because text input becomes possible, it is also possible according to the invention to use for instance chat applications with such a system.

The pairing of a mobile device with the remote server or local rendering device can be executed in that the server displays a code on the screen, this code being entered into the mobile computer by means of for instance text input. Once the code has been recognized as authentic, the user can use the mobile computer to manipulate the session to which he/she has rights. Alternatively, it is possible to pair showing on the screen a code which is recorded by means of one of the cameras of the mobile computer. The code can then be forwarded by means of a challenge to the remote server and/or local rendering device in order to effect the authentication of the user of the mobile computer. Pairing has the further advantage of providing additional security, so that instructions can also be applied for the purpose of purchasing for instance video on-demand or other pay services such as games. It is once again stated here that the present invention has been changed specifically for the purpose of application in a system as described in Appendix A. The skilled person in the field will be able to interpret the present disclosure clearly in the light of the disclosure of this document and in combination with individual aspects of the two documents. Further parts of the disclosure of Appendix A are likewise deemed to be incorporated in the present document in order to form part of the disclosure of this document.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

While the invention has been particularly shown and described with reference to specific embodiments, it will be understood by those skilled in the art that various changes in form and detail may be made therein without departing from the spirit and scope of the invention as defined by the appended clauses. As will be apparent to those skilled in the art, techniques described above for panoramas may be applied to images that have been captured as non-panoramic images, and vice versa.

Embodiments of the present invention may be described, without limitation, by the following clauses. While these embodiments have been described in the clauses by process steps, an apparatus comprising a computer with associated display capable of executing the process steps in the clauses below is also included in the present invention. Likewise, a computer program product including computer executable instructions for executing the process steps in the clauses below and stored on a computer readable medium is included within the present invention.

1-19. (canceled)

20. A method for manipulating the display of images of a user interface on a television of a cable television subscriber, the television being connected to a remote server using a data network, the method comprising:
at the remote server, receiving from a mobile computer using the data network, manipulation instructions pertaining to scrolling, sliding, rotating, or zooming the user interface;
at the remote server, assembling encoded fragments into a video stream according to a predetermined format on the basis of the manipulation instructions; and
at the remote server, transmitting the video stream toward the television for display.

21. The method of claim 20, wherein the manipulation instructions comprise sliding finger movements for scroll instructions or slide instructions.

22. The method of claim 20, wherein the manipulation instructions comprise pinching finger movements for zoom instructions.

23. The method of claim 20, wherein the manipulation instructions are generated by means of multiple touches.

24. The method of claim 20, wherein the mobile computer comprises a movement detector or a gravity detector, and the manipulation instructions are generated by means of moving the control device.

25. The method of claim 20, wherein the manipulation instructions comprise text input, speech input, or image input.

26. The method of claim 20, wherein the mobile computer includes a mobile phone or a PDA.

27. A computer program product for manipulating the display of images of a user interface on a television of a cable television subscriber, the television being connected to a remote server using a data network, the computer program product comprising a non-transitory computer-readable medium on which is stored computer program code for:
receiving from a mobile computer using the data network, manipulation instructions pertaining to scrolling, sliding, rotating, or zooming the user interface;
assembling encoded fragments into a video stream according to a predetermined format on the basis of the manipulation instructions; and
transmitting the video stream toward the television for display.

28. The method of claim 27, wherein the manipulation instructions comprise sliding finger movements for scroll instructions or slide instructions.

29. The method of claim 27, wherein the manipulation instructions comprise pinching finger movements for zoom instructions.

30. The method of claim 27, wherein the manipulation instructions are generated by means of multiple touches.

31. The method of claim 27, wherein the mobile computer comprises a movement detector or a gravity detector, and the manipulation instructions are generated by means of moving the control device.

32. The method of claim 27, wherein the manipulation instructions comprise text input, speech input, or image input.

33. The method of claim 27, wherein the mobile computer includes a mobile phone or a PDA.

34. A computer system for manipulating the display of images of a user interface on a television of a cable television subscriber, the television being connected to the computer system using a data network, the computer system comprising:
a receiver for receiving from a mobile computer using the data network, manipulation instructions pertaining to scrolling, sliding, rotating, or zooming the user interface;
an assembler for assembling encoded fragments into a video stream according to a predetermined format on the basis of the manipulation instructions; and
a transmitter for transmitting the video stream toward the television for display.

35. The computer system of claim 34, wherein the manipulation instructions comprise sliding finger movements for scroll instructions or slide instructions.

36. The computer system of claim 34, wherein the manipulation instructions comprise pinching finger movements for zoom instructions.

37. The computer system of claim 34, wherein the manipulation instructions are generated by means of multiple touches.

38. The computer system of claim 34, wherein the mobile computer comprises a movement detector or a gravity detector, and the manipulation instructions are generated by means of moving the control device.

39. The computer system of claim 34, wherein the manipulation instructions comprise text input, speech input, or image input.

40. The computer system of claim 34, wherein the mobile computer includes a mobile phone or a PDA.
